(19) United States
(12) Patent Application Publication
(10) Pub. No.: US 2007/0044578 A1
(43) Pub. Date: Mar. 1, 2007

(54) SAMPLING DEVICE

(76) Inventor: John Shane Jones, Reno, NV (US)

Correspondence Address: IAN F. BURNS & ASSOCIATES, P.O. BOX 71115, RENO, NV, 89570, US

(21) Appl. No.: 11/467,089

(22) Filed: Aug. 24, 2006

Related U.S. Application Data
(60) Provisional application No. 60/713,587, filed on Aug. 31, 2005.
(60) Provisional application No. 60/766,818, filed on Feb. 13, 2006.

(51) Int. Cl. G01N 1/22

(52) U.S. Cl. 73/864

(57) ABSTRACT

A sampling device for collecting samples of airborne substances. The sampling device includes a housing that has an end that can be connected to a vacuum source and another end that can be connected to a sample cassette. An adjustable opening is located in the housing. The adjustable opening operates to adjust the airflow rate through the housing. A rotameter is mounted in the housing. The rotameter measures the airflow rate through the housing.

### CROSS REFERENCE TO RELATED APPLICATIONS

This application claims priority to U.S. provisional patent application Ser. No. 60/713,587, filed Sep. 19, 2005, and U.S. provisional application Ser. No. 60/766,818, filed Feb. 13, 2006, the contents of which are herein incorporated by reference.

### BACKGROUND

1. Field of the Invention

The present invention relates to an air sampling device that is used to collect samples of substances in air, such as particulates and contaminants. In particular, the invention relates to an air sampling device that can be used with various sampling media. The sampling device can adjust the flow rate of air that passes through the sampling device.

2. Description of the Related Art

Sampling can be used to measure and identify particles that are carried by a gaseous media in an environment. The samples can be analyzed by an analytical laboratory in order to determine information relative to the concentration of specific target analytes. For example, indoor air can be monitored for particles of biological origin such as fungal spores. Other particles that can be sampled include, but are not limited to, viable and nonviable fungal spores, bacteria, viruses, pollen, skin cells, fibers, chemicals, asbestos, lead and dust.

There are various prior art sample collecting devices currently available. A conventional filter holding sampling cassette is commercially available under the trade name of Air-O-Cell™. This air sampler includes a two part cassette having an inlet and an outlet which is connected to a vacuum source. Between the two parts of the cassette is a filter media. In operation, particles enter through the inlet and are retained by the filter.

These sample filter media are commercially available to the public. However, without special expensive equipment to calibrate the air flow. It is difficult for most nonprofessionals to accurately carry out tests.

Therefore, there is a current need for a sampling device that can provide solutions to the problems associated with the present special expensive equipment and expert operators. More specifically, a sampling device is needed that can adjust an airflow rate through a sample holder to a uniform value for all collected samples and that can be used with a wide variety and sizes of vacuum sources. Furthermore, there is a need for an inexpensive and easily operated sampling device that is capable of quantifying contaminants.

### SUMMARY

Advantages of One or More Embodiments of the Present Invention

The various embodiments of the present invention may, but do not necessarily, achieve one or more of the following advantages:

provide a sampling device with an airflow regulator that can adjust the rate of airflow through a sample holder;

provide a sampling device for collecting air borne particles;

provide a sampling device that can be used with a wide variety of vacuum sources;

provide a sampling device that can be used with a wide variety of different size vacuum hoses and nozzles;

provide a sampling device that is simple for a nonprofessional to operate,

provide a sampling device that can be used with various types of sampling media.

provide a sampling device with a rotameter that can measure an airflow rate; and

provide a sampling device that can inexpensively collect airborne particles onto a specific media.

These and other advantages may be realized by reference to the remaining portions of the specification, claims, and abstract.

### BRIEF DESCRIPTION

The present invention comprises a sampling device that includes a housing that has a first and second end. The first end can be connected to a vacuum source and the second end is adapted to be connected to a sample media. An adjustable opening is located in the housing. The adjustable opening operates to adjust the airflow rate through the housing. A rotameter is mounted in the housing. The rotameter measures the airflow rate through the housing.

The present invention further comprises a method of collecting a sample. The method includes connecting an airflow regulator to a vacuum source. The airflow rate through the airflow regulator is adjusted to a predetermined airflow rate. A sample media is attached to the airflow regulator. A sample is collected in the sample media. The sample media is removed from the airflow regulator.

The present invention further comprises a sampling device that includes a housing that has a rotameter mounted in the housing. The rotameter regulates an airflow. A first tube is connected to the rotameter and is in fluid communication with a vacuum source. A second tube is connected to the rotameter and is in fluid communication with a sample cassette.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

The embodiments of the present invention are shown in the drawings, wherein:

FIG. 1 is substantially a front perspective view of an embodiment of a sampling device in accordance with the present invention.

FIG. 2 is substantially a side view of the airflow regulator of FIG. 1 with the sleeve adjusted to allow unrestricted airflow into the aperture.

FIG. 3 is substantially a side view of the airflow regulator of FIG. 1 with the sleeve adjusted to restrict airflow into the aperture.

FIG. 4 is substantially a left side view of FIG. 2.

FIG. 5 is substantially a right side view of FIG. 2.

FIG. 6 is substantially a side cross-sectional view of the airflow regulator taken along section line AA of FIG. 4.

FIG. 7 is substantially an enlarged front perspective view of the sampling cassette of FIG. 1.

FIG. 8 is substantially a top view of FIG. 7.

FIG. 9 is substantially a bottom view of FIG. 7.

FIG. 10 is substantially side cross-sectional view of the sampling cassette taken along section line BB of FIG. 8.

FIG. 11 is substantially a flow chart of an embodiment of a method of collecting a sample in accordance with the present invention.

FIG. 12 is substantially a perspective view of an alternative embodiment of a sampling device in accordance with the present invention.

FIG. 13 is substantially a left-side cross-section view of the sampling device of FIG. 12.

FIG. 14 is substantially a right-side cross-section view of the sampling device of FIG. 12.

FIG. 15 is substantially a flow chart of an embodiment of a method of collecting a sample in accordance with the present invention.

### DESCRIPTION OF THE EMBODIMENTS

In the following detailed description of the embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

Sampling Device

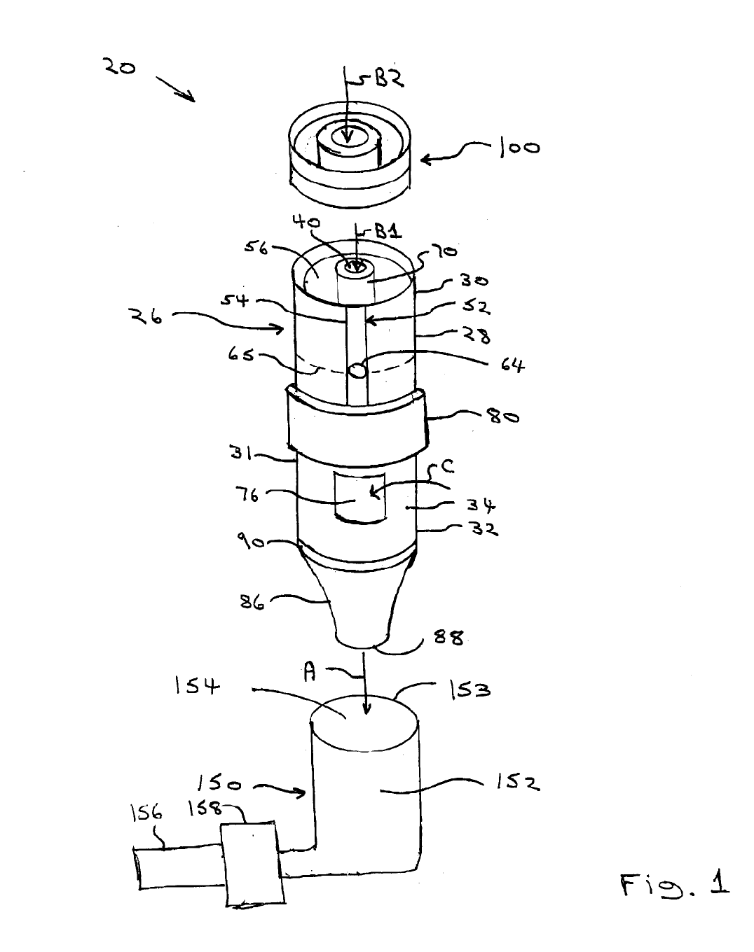

The present invention comprises a sampling device or assembly, generally indicated by reference number 20. Referring to FIG. 1, sampling device 20 can include an airflow regulator 26, a sample holder or cassette 100 and a vacuum source 150. The airflow regulator 26 can be connected with the vacuum source 150 in order to regulate or adjust the airflow generated by vacuum source 150. The sample holder or cassette 100 can be attached to airflow regulator 26 such that regulated airflow is drawn into and passes through sample holder 100.

Vacuum source 150 can be a conventional vacuum cleaner as commonly found in households, such as an upright or canister vacuum cleaner. Any vacuum source can be used including vacuum pumps, shop or factory vacuums, upright or canister vacuum cleaners or portable vacuum cleaners. Vacuum source 150 can include a hose 152 with a nozzle 153. A bore 154 is located in nozzle 153. Hose 152 would be connected to a source of vacuum such as a motor 156 and pump 158.

The regulated airflow passing through sample holder 100 allows the sample holder to collect a uniform and consistent sample in accordance with a set airflow rate. The uniform airflow rate allows for better comparisons between collected samples and ensures that the sample holder will trap and collect the particle sizes that are of interest while at the same time allowing the use of any vacuum source.

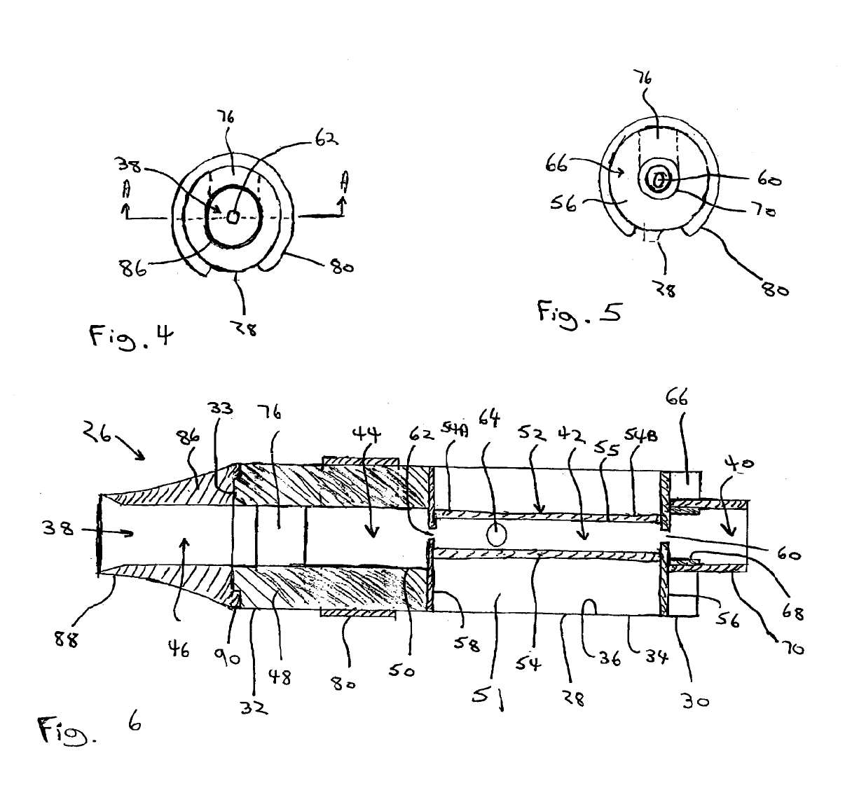

Referring to FIGS. 1-6, an airflow regulator generally indicated by reference number 26 is shown. Airflow regulator 26 can include a cylindrical housing 28 that has ends 30 and 32 and a center portion 31. Housing 28 may be formed at least partially from a material that is transparent such as acrylic, plastic or glass. Housing 28 may be formed by casting, molding or machining. Housing 28 further has an outer surface 34 and an inner surface 36.

A bore 38 extends entirely through housing 28 between ends 30 and 32. Bore 38 includes several portions. Bore 38 has a bore portion 40, bore portion 42, bore portion 44 and a bore portion 46. Bore portions 42 and 44 are located within housing 28.

A thick annular wall 48 can be located in housing 28 toward end 32. Annular wall 48 has an inner surface 50 that defines bore portion 44. Annular wall 48 has a raised step 33.

An adjustable opening or aperture 76 is located in annular wall 48. Aperture 76 is connected to bore 44 and is in fluid communication with bore 44 such that air can flow from outside of housing 28 through aperture 76 and into bore 44. Moveable sleeve 80 is slidably mounted around outer surface 34. Sleeve 80 is C-shaped and can be press fit around a portion of outer surface 24. Sleeve 80 can be slid or moved in order to partially close off or adjust the size of adjustable opening 76.

A tapered reducer 86 is mounted over end 32 of housing 28. Reducer 86 has an end 88 and a lip 90. Lip 90 is press fit around raised step 33. Bore portion 46 passes through reducer 86. Reducer 86 can be formed from a pliable material such as rubber or plastic. Reducer 86 can mate with nozzle 153 of hose 152. End 88 would extend into bore 154. The tapered diameter of reducer 86 allows the airflow regulator to be connected to or mate with a wide variety of different dimension hoses, pipes, nozzles and openings.

A rotameter 52 can be mounted to housing 28 inside cavity 51. A rotameter is a device for measuring airflow rates and can also be called an area flow meter. Many existing rotameters may be used with the present invention, such as model MMF-50-PV, available from Dwyer Instruments, Inc., Michigan City, Ind. Rotameter 52 includes a float ball 64 mounted within a transparent variable diameter or tapered tube 54. Tube 54 is only slightly tapered such that it is not visible in FIG. 6. Tube 54 has ends 54A and 54B and an inner surface 55. Bore 42 is located within tube 54 and is defined by inner surface 55. Tube end 54A is slightly larger in diameter than tube end 54B. Tube 54 may be formed at least partially from a material that is transparent such as acrylic, plastic or glass such that float ball 64 can be viewed through tube 54. Float ball 64 can be formed from plastic or metal.

An end plate 56 is connected to tube 54 and is located over end 54B. Hole 60 is located in end plate 56. An end plate 58 is connected to annular wall 48 and tube 54 and is located over end 54A. Hole 62 is located in end plate 56. Float ball 64 is moveably mounted within tube 54. A sight line 65 can be placed on outer surface 34. Sight line 65 can be painted on or can be molded into outer surface 34. Airflow can enter the rotameter through hole 60 and exit through hole 62.

When no vacuum is applied and no air is passing through the rotameter, the float ball 64 rests on the bottom of the tube at end 54B over hole 60 due to the force of gravity. As airflow starts to be applied through the tube, the density of the float ball causes the float to remain toward the bottom of, and slightly above hole 60. The space between the float ball 64 and inner surface 55 allows for airflow around the float ball. As airflow increases in the tube, the pressure drop increases. When the pressure drop is sufficient, the float ball will rise to indicate the amount or rate of airflow. The higher the flow rate, the greater the pressure drop. The higher the pressure drop, the farther up the tube the float ball will rise. With a constant flow rate, the float ball will remain in a constant position in the tube.

A cavity 66 can be formed by housing 28 and end plate 56. Tube 68 is attached to end plate 56 and extends away from end plate 56. Coupler 70 is mounted over tube 68 and extends away from housing end 30. Coupler 70 has a bore portion 40 that passes through. Coupler 70 allows airflow regulator 26 to be connected to sampling cassette 100.

Sampling Cassette

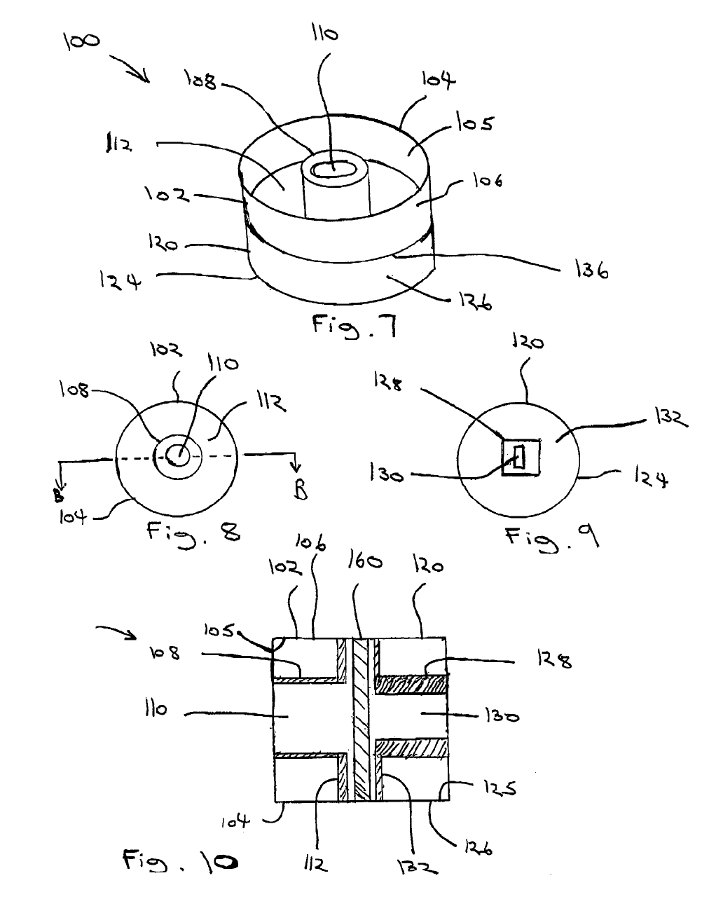

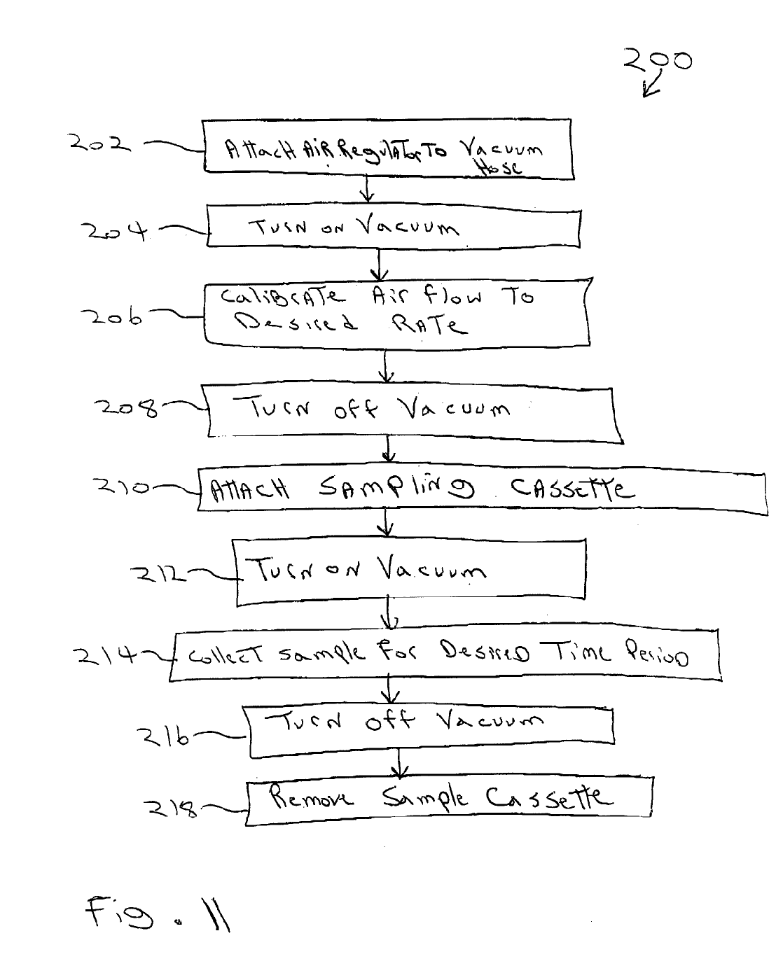

Referring to FIGS. 7-10, a sampling cassette generally indicated by reference number 100 is shown. Sampling cassette 100 maybe a conventional sampling cassette that is commercially available under the name Air-O-Cell™, as well as other sampling cassettes. Sampling cassette 100 can include an upper housing 102 and a lower housing 120. Housings 102 and 120 may be formed at least partially from a material that is transparent such as acrylic, plastic or glass. Housings 102 and 120 may be formed by casting, molding or machining. Upper housing 102 can have an annular wall 104 with an inner surface 105 and an outer surface 106. A round flange 108 extends from wall 112. Bore 110 passes through flange 108.

Lower housing 120 may include an annular wall 124 with an inner surface 125 and an outer surface 126. Lower housing 120 can have a square flange 128 that extends from wall 132. Flange 128 has a bore 130. An ultrasonic weld 136 can hold housing 102 and 120 together as a single unit.

Filter media 160 is mounted between housings 102 and 120 prior to ultrasonic welding. Filter media 160 can be a wide variety of media such as paper, plastic or ceramic. Filter media 160 is retained between walls 112 and 132.

Operation

Turning back to FIG. 1, during operation, air regulator 26 is held in an upright position by the user with the length of housing 28 being parallel to a vertical axis. Sampling device 20 in FIG. 1 is shown upside down relative to its orientation during actual use. In actual use, vacuum source 150 is located above air regulator 26. Air regulator 26 is connected to vacuum source 150 such as a vacuum cleaner hose by inserting reducer 86 into nozzle 153. Reducer 86 forms a seal with nozzle 153. With vacuum source 150 turned on, an amount of airflow designated by arrow A is drawn through bore 38 (FIG. 6) and into nozzle 153. Airflow A has an associated magnitude of volume and pressure.

Airflow B1 is shown entering bore 40 of coupler 70. Airflow C is shown entering aperture 76. During operation, airflow A is made up of the sum of the combination of airflow B1 and airflow C. Airflow B1 is drawn by vacuum source 150 through bores 38, 44, 42, and 40. Airflow B1 is drawn by vacuum source 150 through aperture 76 and bore 38.

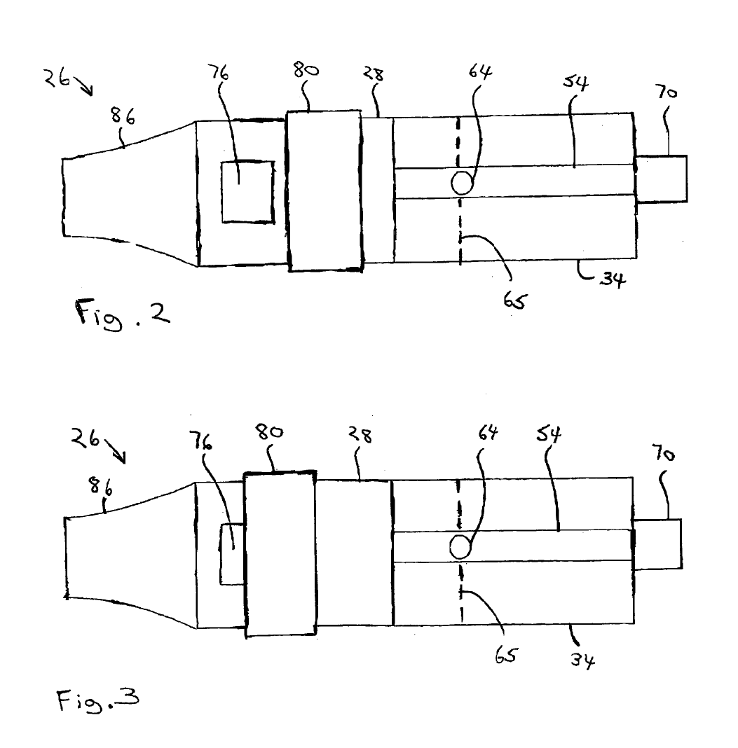

The airflow B1 is calibrated to the desired airflow rate at by moving sleeve 80 over aperture 76. Sleeve 80 changes the proportions of airflows B1 and C entering the air regulator through the aperture and through bore 40 to change. When sleeve 80 is moved such that the size of aperture 76 is increased, such as shown in FIG. 2, the amount of air drawn through aperture 76 by the vacuum source will increase in comparison to the amount drawn through bore 40. When sleeve 80 is moved such that the size of aperture 76 is decreased, such as shown in FIG. 3, the amount of air drawn through aperture 76 by the vacuum source will decrease in comparison to the amount drawn through bore 40.

In this manner, airflow B1 can be set to the same rate with a variety of different vacuum sources that may have different air flow rates. For example, one vacuum cleaner may intake air at a rate of 75 cubic feet per minute and another vacuum cleaner may intake air at a rate of 100 cubic feet per minute. Air regulator 26 allows both of these vacuum cleaners to be used with sampling cassette 100 such that the rate of airflow through the sampling cassette can be adjusted to be the same rate for both vacuum cleaners.

While continuing to hold the regulator in an upright position, sleeve 80 is moved in either direction until float ball 64 is aligned with sight line 65 thereby providing a pre-determined constant airflow B1. Airflow B1 presses on and causes the float ball 65 to rise upwardly in tube 54. With airflow B1 set at a constant value, vacuum source 150 can be turned off and sample cassette 100 attached to coupler 70. The vacuum source 150 can then be turned on and a sample collected for a desired period of time.

Airflow B2 enters sampling cassette 100 through bore 130 (FIG. 10), passes through filter media 160 (FIG. 10) and exits through bore 110 (FIG. 10) into bore 40. Airflow B2 is equal in magnitude to airflow B1. It is noted that Airflow B2 contains particles and substances that are desired to be collected. The particles and substances are retained by filter media 160. Vacuum source 150 is then turned off.

The sample cassette 100 can be removed from the air regulator 26 and sent to an appropriate facility for analysis of the particulates trapped by filter media 160. If desired, another sample cassette 100 may be attached to airflow regulator 26 for collection of another sample.

Method of Use

Turning now to FIG. 11, a method of collecting a sample generally indicated by reference number 200 is shown. Method 200 includes attaching the air regulator to a vacuum source at step 202. The operator holds the air regulator in an upright position. At step 204, the vacuum source is turned on creating airflow through the air regulator. The airflow is calibrated or adjusted to the desired rate at step 206 by moving the sleeve over the aperture. This causes the proportion of air entering the regulator through the aperture and through the bore to change. When the sleeve is moved such that the size of the aperture is increased, the amount of air drawn though the aperture by the vacuum source will increase in comparison to the amount drawn through the bore. When the sleeve is moved such that the size of the aperture is decreased, the amount of air drawn though the aperture by the vacuum source will decrease in comparison to the amount drawn through the bore.

With the airflow regulator held in an upright position, the sleeve is moved until the float ball is aligned with the sight line. This provides a pre-determined constant airflow rate through the bore and also through the sampling cassette after it is attached.

At step 208, the vacuum source is turned off. The sampling cassette is connected to the air regulator at step 210. At step 212, the vacuum source is turned back on. A sample is collected in the sampling cassette for a desired period of time at step 214. At step 216, the vacuum source is turned off. The sample cassette is removed from the air regulator at step 218. The sample cassette may now be sent to an appropriate facility for analysis of the collected particles and substances.

It is noted that sampling device 20 is not limited for use in collecting samples. Sampling device 20 may be used in any application where the rate of airflow is needed to be adjusted or regulated. Sampling device 20 may also be used with gases other than air such as nitrogen or methane.

Alternative Embodiment

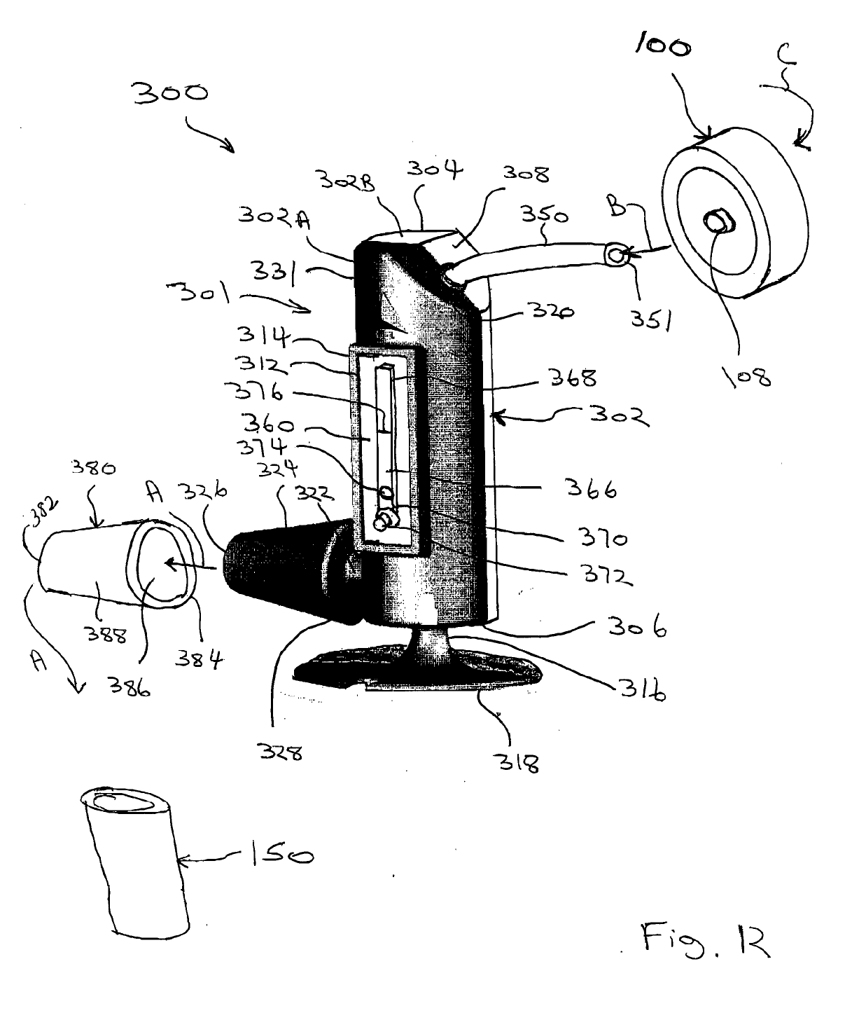

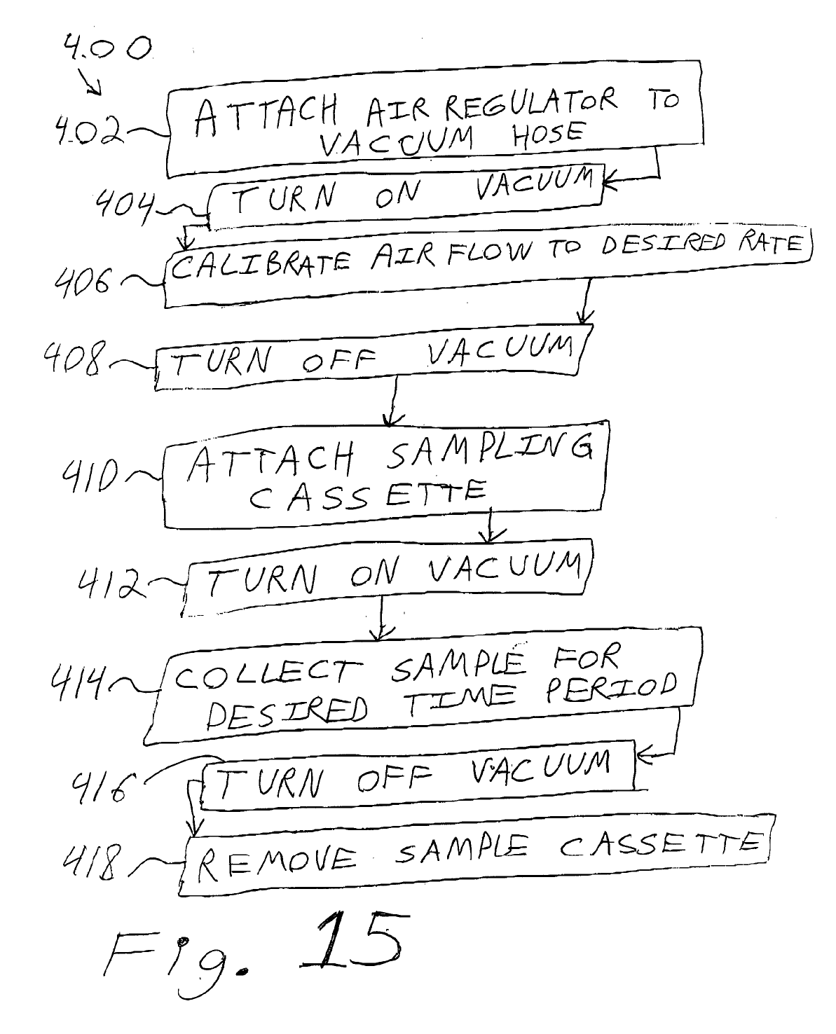

Turning now to FIGS. 12-14, an alternative embodiment of a sampling device 300 in accordance with the present invention is shown. Sampling device 300 can include an airflow regulator 301 that can be connected with a vacuum source 150 and a sampling cassette 100.

Airflow regulator 301 can have a cylindrical housing 302 that has two halves 302A and 302B and ends 304 and 306. Housing 302 can be formed from any suitable material, such as injection molded plastic. Housing 302 may have an angled surface 308 and a cavity 310. Housing 302 can include an inner surface 330 and an outer surface 331. An opening or window 312 is located in housing 302. Rim 314 is located around window 312. Pedestal 316 is connected with housing 302 and a base 318. Base 318 can support sampling device 300. Angled surface 308 has a hole 320.

Nozzle 324 is connected to housing 302 by a pipe 322. Nozzle 324 has ends 326 and 328. Several tube holders 336 are located within cavity 310. A pair of tabs 338 are mounted on either side of window 312 and extend into cavity 310. Inner surface 330 has snap fit holes 340 that extend into cavity 310. Inner surface 330 has snap fit projections 342 that extend into cavity 310. Snap fit projections 342 mate with snap fit holes 340 such that housing halves 302A and 302B are retained to each other to form housing 302.

A rubber or plastic tube 350 is mounted in cavity 310. Tube 350 has ends 351 and 352. Tube 350 is held in housing portion 302A by tube holder 336. Rubber or plastic tube 354 has ends 355 and 356. A rotameter 360 is mounted in window 312. Rotameter 360 has a housing 361 that is retained in window 312 by tabs 338. Rotameter 360 has ports 362 and 364. Tube end 352 is connected to port 364. Tube end 355 is connected to port 362. Tube end 351 extends outwardly from angled surface 308 and can mate with sampling cassette 100. Sampling cassette 100 is the same as previously described. Tube end 356 is mounted in and retained by tube 322. Tube end 356 is supported by tube holder 336 in housing portion 302A.

Rotameter 360 is a device for measuring airflow rates and can also be called an area flow meter. Rotameter 360 includes a float ball 374 mounted within a transparent variable diameter or tapered tube 366. Tube 366 is only slightly tapered such that it is not visible in FIG. 12. Tube 54 has ends 368 and 370 and an inner surface 55. Bore 369 is located within tube 366. Tube end 368 is slightly larger in diameter than tube end 370. Tube 366 may be formed at least partially from a material that is transparent such as acrylic, plastic or glass such that float ball 374 can be viewed through tube 366. Float ball 374 can be formed from plastic or metal. A sight line 376 can be placed on tube 366. Sight line 376 can be painted on or can be molded into tube 366. Airflow can enter the rotameter through port 364 and exit through port 362. A valve knob 372 is mounted to a regulator valve 373. Valve 373 is mounted in tube 366 and can control the flow of air between ports 364 and 362 by the turning of valve knob 372. Regulator valve 373 can be a screw type valve or can be a butterfly valve.

When no vacuum is applied and no air is passing through the rotameter, the float ball 374 rests on the bottom of the tube at end 370 due to the force of gravity. As airflow starts to be applied through the tube, the density of the float ball causes the float to remain toward the bottom end 370. The space between the float ball 374 and tube 366 allows for airflow around the float ball. As airflow increases in the tube, the pressure drop increases. When the pressure drop is sufficient, the float ball will rise to indicate the amount or rate of airflow. The higher the flow rate, the greater the pressure drop. The higher the pressure drop, the farther up the tube the float ball will rise. With a constant flow rate, the float ball will remain in a constant position in the tube.

A tapered reducer or coupler 380 can be mounted over nozzle 324. Reducer 380 has ends 382 and 384. Reducer 380 has an inner surface 386 and an outer surface 388. Reducer 380 can be formed from a pliable material such as rubber or plastic. Reducer 380 can mate with nozzle 324. The tapered diameter of reducer 380 allows the sampling device 300 to be connected to or mate with a wide variety of different dimension hoses, pipes, nozzles and openings.

Operation

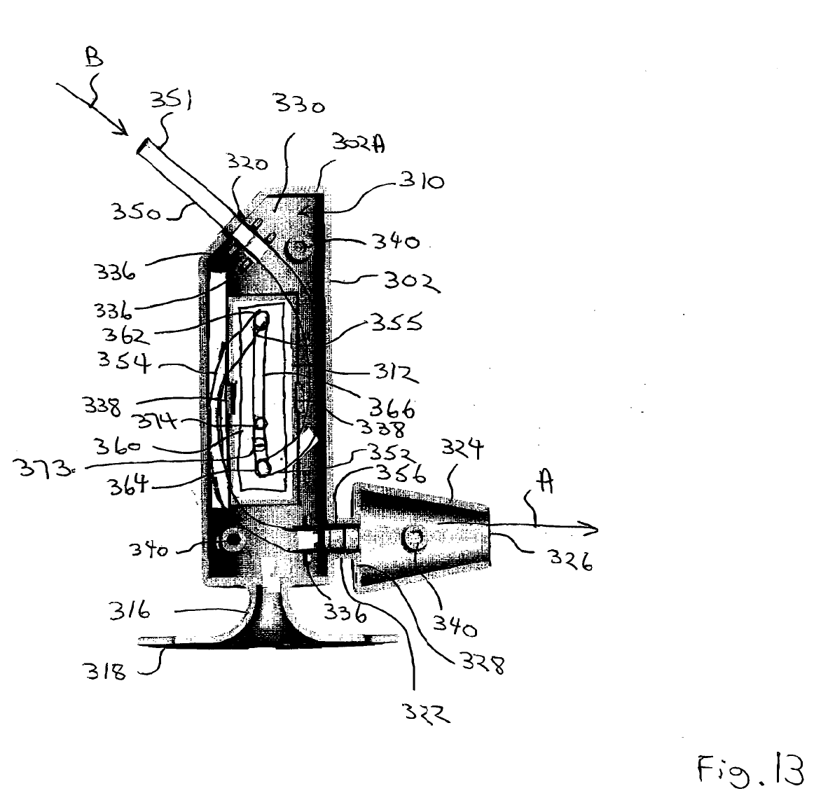

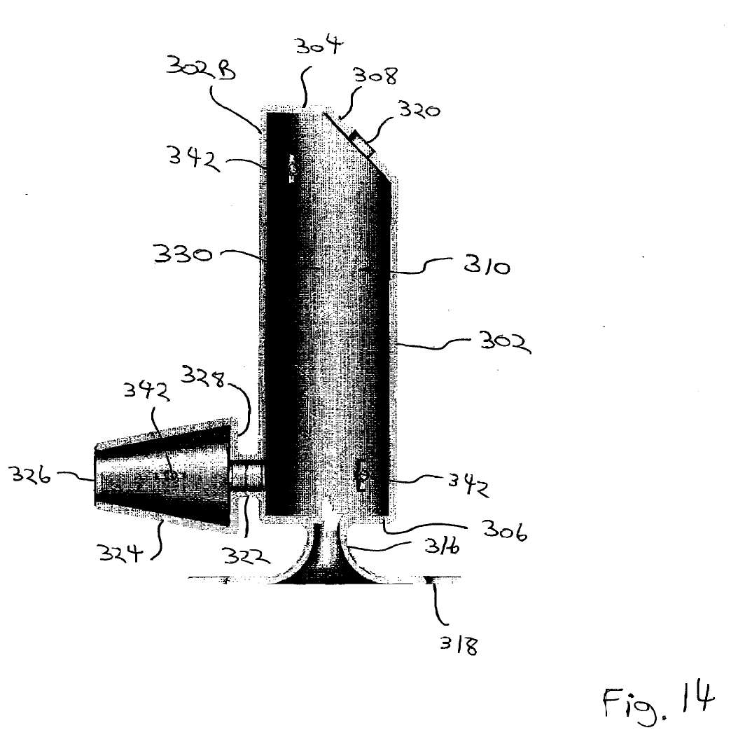

With reference to FIGS. 12 and 13, during operation, air regulator 301 is connected to vacuum source 150 such as a vacuum cleaner hose by inserting reducer 380 over nozzle 324 and inserting reducer 380 into vacuum source 150. With vacuum source 150 turned on, an amount of airflow designated by arrow A is drawn through bore nozzle 324, reducer 380 and into vacuum source 150. Airflow A has an associated magnitude of volume and pressure.

Airflow B is shown entering tube end 351 which can be connected to sampling cassette 100. During operation, airflow B is drawn by vacuum source 150 through tube 350, rotameter 360 and tube 354.

The airflow B is calibrated to the desired airflow rate at by rotating valve knob 372 and valve 373 until the float ball is aligned with sight line 376. Valve 373 changes the amount of air flowing through the rotameter. In this manner, airflow B can be set to the same rate with a variety of different vacuum sources that may have different air flow rates. For example, one vacuum cleaner may intake air at a rate of 75 cubic feet per minute and another vacuum cleaner may intake air at a rate of 100 cubic feet per minute. Sampling device 300 or air regulator 301 allows both of these vacuum cleaners to be used with sampling cassette 100 such that the rate of airflow through the sampling cassette can be adjusted to be the same rate for both vacuum cleaners.

When float ball 374 is aligned with sight line 376 a pre-determined constant airflow B is provided at tube end 351. With airflow B set at a constant value, vacuum source 150 can be turned off and sample cassette 100 can be attached to tube end 351 by pushing tube end 351 over flange 108. The vacuum source 150 can then be turned on and a sample collected for a desired period of time.

Airflow C is also pulled through sampling cassette 100 and passes through filter media 160 (FIG. 10) and exits through into tube end 351 as airflow B. Airflow B is equal in magnitude to airflow C. It is noted that Airflow C contains particles and substances that are desired to be collected. The particles and substances are retained by filter media 160. Vacuum source 150 is then turned off.

The sample cassette 100 can be removed from the air regulator 301 and sent to an appropriate facility for analysis of the particulates trapped by filter media 160. If desired, another sample cassette 100 may be attached to airflow regulator 301 for collection of another sample.

Method of Use

Turning now to FIG. 15, a method of collecting a sample using sampling device 300 is shown. Method 400 includes attaching the air regulator to a vacuum source at step 402. At step 404, the vacuum source is turned on creating airflow through the air regulator. The airflow is calibrated or adjusted to the desired rate at step 406 by rotating the valve knob. This increases or decreases the amount of air flowing through the rotameter. The knob is rotated until the float ball is aligned with the sight line. This provides a pre-determined constant airflow rate through the air regulator and also through the sampling cassette after it is attached.

At step 408, the vacuum source is turned off. The sampling cassette is connected to the air regulator at step 410. At step 412, the vacuum source is turned back on. A sample is collected in the sampling cassette for a desired period of time at step 414. At step 416, the vacuum source is turned off. The sample cassette is removed from the air regulator at step 418. The sample cassette may now be sent to an appropriate facility for analysis of the collected particles and substances.

### CONCLUSION

It can thus be realized that the certain embodiments of the present invention can provide a sampling device for collecting accurate, consistent, uniform samples of airborne particulates using a variety of sample media. The present invention can be used with a wide variety and sizes of vacuum sources, such as household vacuum cleaners.

Although the description above contains many specifications, these should not be construed as limiting the scope of the invention but as providing illustrations of some of present embodiments of this invention. Thus, the scope of the invention should be determined by the appended claims and their legal equivalents rather than by the examples given.

What is claimed is:

1. A sampling device comprising:
a) an airflow regulator, the airflow regulator being adapted to be connected with a vacuum source, the airflow regulator being adapted to regulate an airflow rate from the vacuum source; and
b) the airflow regulator being adapted to be connected to a sample holder such that regulated airflow passes through the sample holder.

2. The sampling device of claim 1, wherein the airflow regulator has a rotameter for measuring the airflow rate.

3. The sampling device of claim 1, wherein the airflow regulator has a housing, the housing having a bore passing therethrough.

4. The sampling device of claim 3, wherein an aperture is located in the housing and is in communication with the bore.

5. The sampling device of claim 4, wherein a sleeve is mounted to the housing, the sleeve being adapted to move over the aperture such that the airflow rate can be regulated.

6. The sampling device of claim 3, wherein a reducer is mounted to a first end of the housing.

7. The sampling device of claim 3, wherein a coupler is mounted to a second end of the housing.

8. The sampling device of claim 1, wherein the vacuum source is a vacuum cleaner.

9. A sampling device comprising:
a) a housing having a first end, a second end and a center portion, the first end being adapted to be connected to an airflow source;
b) a bore passing through the housing between the first and second ends;
c) an aperture located in the housing and in communication with the bore; and
d) a sleeve mounted to the housing, the sleeve being adapted to slide over the aperture such that an airflow rate at the second end can be regulated.

10. The airflow regulator of claim 9, wherein the sleeve at least partially surrounds an outer surface of the housing.

11. The airflow regulator of claim 9, wherein a rotameter is mounted in the bore for measuring the airflow rate.

12. The airflow regulator of claim 11, wherein the rotameter further comprises:
a) a tube mounted in the bore;
b) a moveable ball located in the tube; and
c) a sight line located on the housing.

13. The airflow regulator of claim 11, wherein the housing is at least partially transparent such that the rotameter can be viewed through the housing.

14. The airflow regulator of claim 9, wherein the second end is adapted to be connected with a sampling cassette.

15. The airflow regulator of claim 9, wherein a reducer is mounted to the first end, the reducer being adapted to mate with a plurality of different size nozzles.

16. A method of collecting a sample, but not necessarily in the order shown, comprising:
a) connecting an airflow regulator to a vacuum source;
b) adjusting an airflow rate through the airflow regulator to a predetermined airflow rate;
c) attaching a sample holder to the airflow regulator;
d) allowing air to pass through the sample holder for a period of time; and
e) removing the sample holder from the airflow regulator.

17. The method of claim 16, wherein adjusting the airflow rate further comprises:
a) viewing a rotameter, the rotameter including a float and a sight line;
b) adjusting the rotameter to adjust the airflow; and
c) aligning the float with the sight line.

18. The method of claim 16, further comprising:
a) collecting the sample for a period of time.

19. A sampling device comprising:
a) a housing having a first and second end, the first end being connectable to a vacuum source and the second end being connectable to a sample cassette;
b) an adjustable opening located in the housing, the adjustable opening operable to adjust an airflow rate through the housing; and
c) a rotameter mounted in the housing, the rotameter operable to measure the airflow rate through the housing.

20. The sampling device of claim 19, wherein the rotameter further comprises:
a) a tube mounted in the housing;
b) a moveable ball located in the tube; and
c) a sight line located on the housing and juxtaposed to the tube.

21. The sampling device of claim 20, wherein the tube has a variable diameter.

22. The sampling device of claim 20, wherein the housing and the tube are at least partially transparent such that the ball can be viewed inside the tube.

23. The sampling device of claim 19, wherein the adjustable opening includes a sleeve slidably mounted to the housing.

24. An airflow regulator comprising:
a) a housing;
b) a rotameter mounted in the housing, the rotameter being adapted to regulate an airflow,
c) a first tube connected to the rotameter, the first tube being adapted to be in fluid communication with a vacuum source; and
d) a second tube connected to the rotameter, the second tube being adapted to be in fluid communication with a sample cassette.

25. The airflow regulator of claim 24, wherein the rotameter further comprises: a) a third tube; b) a moveable ball located in the third tube; and c) a sight line located on the third tube.

26. The airflow regulator of claim 25, wherein the third tube is at least partially transparent such that the ball can be viewed.

27. The airflow regulator of claim 24, wherein a reducer is mounted to the housing.

28. A sampling device comprising:
a) housing means;
b) airflow regulation means for adjusting an airflow rate, the airflow regulation means mounted in the housing means, the airflow regulation means being adapted to be connected with a sample means; and
c) nozzle means in communication with the air flow regulation means for connecting to a vacuum source.

29. The sampling device of claim 28, wherein the airflow regulation means comprises a rotameter.

30. The sampling device of claim 29, wherein a first tube is connected between the nozzle means and the rotameter.

31. The sampling device of claim 29, wherein a second tube is connected between the sample means and the rotameter.

32. The sampling device of claim 29, wherein the rotameter further comprises:
a) a third tube;
b) a ball located in the third tube; and
c) a sight line located on the third tube.

33. The sampling device of claim 28, wherein the nozzle means are connected to the housing means.

34. The sampling device of claim 28, wherein reducing means are mounted to the nozzle means.
